(19) United States
(12) Patent Application Publication
(10) Pub. No.: US 2012/0066004 A1
(43) Pub. Date: Mar. 15, 2012

(54) METHOD AND SYSTEM FOR PERSONAL INSURANCE COMPARISON AND ADVICE

(76) Inventor: Chang Young Lee, Oakland Gardens, NY (US)

(21) Appl. No.: 13/194,955

(22) Filed: Jul. 31, 2011

Related U.S. Application Data
(60) Provisional application No. 61/381,418, filed on Sep. 9, 2010.

(51) Int. Cl. G06Q 40/00

(52) U.S. Cl. 705/4

(57) ABSTRACT

Personally unidentifiable information (“PUI”) is received from a user at a computer device. One or more records from a database of records that match some or all of the received PUI is determined by the computing device. Insurance advice is provided to the user based on the determined one or more records by the computing device.

### CROSS-REFERENCE TO RELATED APPLICATIONS

This application claims priority to provisional application No. 61/381,418 filed Sep. 9, 2010. The contents of which are hereby incorporated by reference in their entirely.

### BACKGROUND

With recent advancements in computer networks like the internet, a user or a customer can get insurance quotations and can purchase insurance products online. However, while convenient, a user is generally required to provide personal information including security sensitive information to receive even a quotation. The disclosure of such personal information may make the user at risk of identity theft.

### SUMMARY

In an implementation, personally unidentifiable information (“PUI”) is received from a user at a computer device. One or more records from a database of records that match some or all of the received PUI is determined by the computing device. Insurance advice is provided to the user based on the determined one or more records by the computing device.

Implementations may include some or all of the following features. Some or all of the PUI may be validated, and if validated, the PUI may be stored as a record in the database. The PUI may include a current insurance premium and an email address, and validating some or all of the PUI may include determining that the current insurance premium is within an acceptable premium range and that the email address is a valid email address. The PUI may include a zip code and a current insurance premium paid by the user, and determining one or more records that match some or all of the received PUI may include determining one or more records that have a same zip code as the PUI. A highest premium paid by users, a lowest premium paid by users, and an average premium paid by users may be calculated using the determined one or more records that have a same zip code as the PUI, and the insurance advice based on the calculated highest premium paid by users, lowest premium paid by users, and average premium paid by users may be provided. The advice may be whether the current insurance premium paid by the user is higher or lower than the average premium paid by users. An insurance agent who purchased a redirection credit with respect to the zip code of the PUI may be determined, and a redirection link may be included in the advice to a website associated with the determined insurance agent where the user can purchase insurance. An indication that the user selected the redirection link may be received, and a redirection link balance associated with the agent may be debited upon receiving the indication. Whether a redirection link balance for an agent has fallen below a threshold may be determined, and the agent may be contacted to purchase additional redirection links if it is determined that a redirection link balance for an agent has fallen below a threshold. The insurance may be automotive insurance. The insurance may be one of homeowner's insurance, motorcycle insurance, condo insurance, co-op insurance, or renter's insurance.

In an implementation, a request to purchase a number of redirection credits from an insurance agent is received at a computing device. The request includes a zip code, an identifier of an insurance company and a type of insurance. A website address corresponding to the redirection request is received by the computing device. The website address is stored with the number of redirection credits by the computing device. A request for insurance advice for the type of insurance and the zip code is received by the computing device. Insurance advice is generated based on the received request by the insurance company. The advice includes an insurance product from the identified insurance company. The received website address is included in the generated advice by the computing device.

Implementations may include some or all of the following features. The generated advice is provided to a user. That the user selected the received website address is determined, and the number of redirection credits is debited. That the number of redirection credits is below a threshold is determined, and the insurance agent is contacted based on the determination. The type of insurance is automobile insurance. The type of insurance is one of homeowner's insurance, motorcycle insurance, condo insurance, co-op insurance, or renter's insurance. Whether the requested redirection credits are available is determined. The advice is whether a current insurance premium paid by the user is higher or lower than the average premium paid by other users.

This summary is provided to introduce a selection of concepts in a simplified form that are further described below in the detailed description. This summary is not intended to identify key or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there are shown in the drawings example constructions of the embodiments; however, the embodiments are not limited to the specific methods and instrumentalities disclosed. In the drawings:

FIG. 1 is an illustration of an exemplary environment for providing and/or receiving insurance quotes;

FIG. 2 is a flowchart showing an example of an insurance quote generation and retrieval method;

FIGS. 3A-3C are illustrations of PUI and PII for various types of insurance types;

FIG. 4 is an example input screen via which a user may provide PUI to a server 110 to receive one or more auto insurance premiums for comparison;

FIG. 5 is an example display screen that may be generated by the system 110 using the information provided by the user interface described in FIG. 4;

FIG. 6 is an illustration of a method for determining a tier or level for a user;

FIG. 7 illustrates a website displayed as a result of a redirection caused by a user selecting one or more displayed results or advices from the matched results frame screen 504 and/or the insurance advice frame screen 503;

FIG. 8 is a flow diagram of a method for collecting of insurance data from general user's input;

FIG. 9 is an example display screen showing a login web page that may be used by an insurance agent 130 or an advertiser 140;

FIG. 10 is an example of a display screen for creating of an access account for an insurance agent 130 or an advertiser 140;

FIG. 11 is an example display screen showing an insurance information search page for use by an insurance agent 130 or an advertisement agency 140;

FIG. 12. is an example results page generated in response to the search page of FIG. 11;

FIG. 13 is an example display screen showing a redirection purchase page for an agent 130;

FIG. 14 is an example of a display screen showing the average premium report ordering page for an advertiser 140;

FIG. 15 is an example display screen showing the average premium report purchased by an advertiser 140; and

FIG. 16. is an exemplary system for implementing aspects described herein;

### DETAILED DESCRIPTION

A method and system for comparing insurance information and for providing insurance advice to a user without requesting a user's Personally Identifiable Information (PII) is described herein. The insurance comparison and advice system described may reduce the threat of possible identity theft and may improve the accuracy of insurance advice.

The information that a user typically provides to an insurance provider may include two parts: personally identifiable information (“PII”) and personally unidentifiable information (“PUI”). The PII may include information that may be used to identify a user and may include information such as physical address, driver license number, social security number, vehicle identification number, etc. In contrast, the PUI may include personal information which may not be used to identify the user and may include information such as a user's zip code, number of young driver(s) (i.e., below twenty five years old) in a user's household, a number of old driver(s) (i.e., above twenty six years old) in a user's household, a number of old car(s) (i.e., older than six years) owned by the user, number of new car(s) (i.e., less than five years old) owned by the users, a liability coverage selected by the user, a number of accidents associated with the user in the last five years, etc. In some implementations, the PUI may further include a current insurance premium paid by the user. Other types of PUI and PII may be used.

A user who in interested in insurance quotes typically wants to know whether he is paying more or less than his neighbors. He may want to find out if he is carrying the proper level of coverage for his area, and which insurance company can provide the best price and level of service. Because of identity theft risks, the user may feel more secure if he can receive his quotations based on PUI, rather than PII. To provide insurance quotes using only PUI, methods and systems are provided to provide an insurance quote using the user's PUI along with insurance information associated with one or more of the user's neighbors.

The insurance companies customarily determine a personal insurance premium for a user using what is known as a “Tier System”. The tier system uses one or more risk factors and assigns various combinations of the factors into unique tier groups or levels. The risk factors typically have hierarchical relationships among them and therefore, some factors may have their own subfactors. Based on the risk factors, the insurance company may assign the user to one or more tiers or levels. In case of auto insurance, the tier system usually splits up the risk factors such as garaging address, age of driver, licensing date, gender, marital status, current occupation, model year, auto maker, model, safety features, usage of auto, annual mileage, liability coverage, property coverage, for example. Other risk factors may also be used.

Typically, these factors may themselves have one or more hierarchies or subfactors. For example, the factor “age of driver” may be divided into “older than 25” and “younger than 25”. In addition, the presence or absences of a factor may lead to the checking of other factors. For example, if the driver is less than 25, licensing data may be required to determine if the user has had a license for more than three years or less than three years (i.e., “licensing date”). Under this relationship, “licensing date” may be a sub factor of “age of driver” and “current occupation” may be a sub factor of “the licensing date”.

Typically, the factors used to classify a user into a hierarchy require only PUI, while the subfactors use PII. However, the particular type of information used for each factor may differ by insurance company.

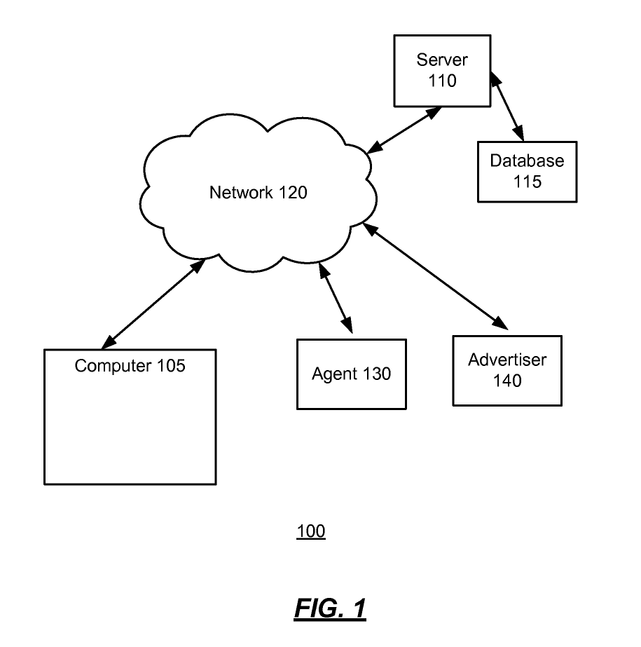

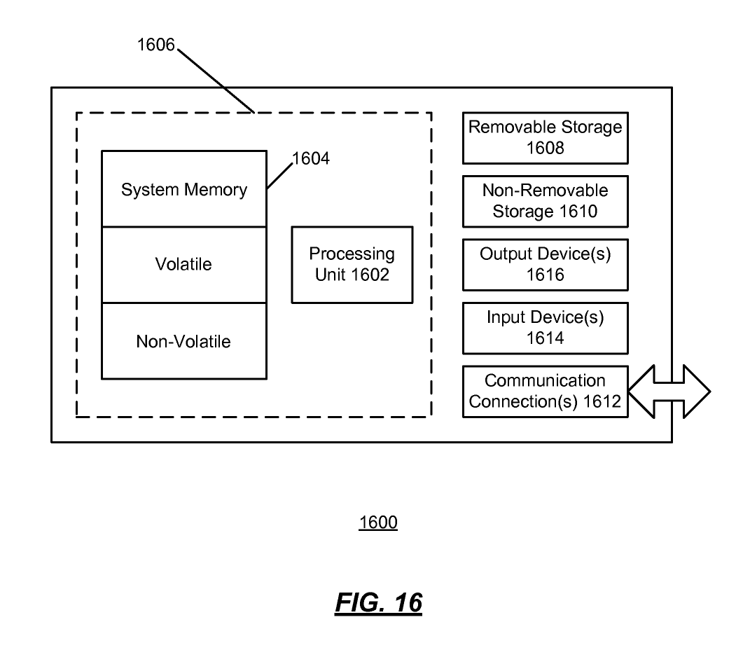

FIG. 1 is an illustration of an example environment 100 for providing and/or receiving insurance quotes. In implementations, a user may input PUI via a website provided by a server system 110 using a personal computer 105. The PUI may include a zip code and a current premium paid by the user. The personal computer 105 and server system 110 may be implemented by a general purpose computing device such as the computing system 1600 illustrated with respect to FIG. 16, for example. In some implementations, the computer 105 and the server system 110 may communicate through a network 120 such as the Internet, for example. The environment 100 may further include one or more insurance agents 130 and advertisers 140 in communication with the system server 110 through the network 120.

The server system 110 may provide one or more insurance quotes to the user through the network 120. The user may connect to the server 110 through the network 120 via the computer 105. The user may be provided with a web page by the server 110 that allows the user to select the type of insurance that the user is interested in. The user may then select the type of insurance that they are interested using a drop down box or other user input device. The types of insurance may include auto, home, life, motorcycle, condo, or any other type of insurance.

After determining the type of insurance that the user is interested in, the server 110 may request certain PUI from the user to use to determine one or more insurance quotes for the user. In some implementations, the PUI requested from the user may be the user's zip code. Other PUI may be requested such as a current premium being paid by the user, or an email address.

The system server 110 may receive the PUI provided by the user and may search for one or more matched records in a database 115. In some implementations, the database 115 may include a variety of records with each record corresponding to a user. Each record may further include PII or PUI regarding the user, along with an identifier of the type of insurance, an identifier of the coverage, an identifier of the insurance provider, and an identifier of the premium that the user pays. Each record may further include the level or tier associated with the user. Other information may also be associated with each record. In some implementations, the information in the records may be provided by one or more insurance providers, or may be information that was provided by other users in the environment 100.

In some implementations, the system server 110 may search for two kinds of records in the database using the PUI provided by the user. First, the system server 110 may search for records that only match the zip code or state of the user, and may use those records to determine the most popular insurance coverage based on the zip code. Most popular may include the popular providers, premiums paid, levels of coverage, etc.

Second, the system server 110 may search the database 115 for any records in the database that match some or all of the user's provided PUI. In some implementations, if the system server 110 finds any matching records, the system server 110 may determine the average premium, the lowest premium, the highest premium, the insurance company or agent 130 providing the lowest premium and the insurance company or agent 130 providing the highest premium from the matching records.

The system server 110 may further compare those two kinds of matching records (the records that match the user's zip code and the records that match some or all of the user's PUI) with the user's PUI and may then determine at which level or tier the user is likely located in insurance premium and coverage. In some implementations, the system server 110 may use the tier or level indicated by the record that most closely matches the user's PUI. In other implementations, the system server 110 may select the most popular tier among the matching records. Other methods may be used.

In other implementations, the system server 110 may then use the determined information (i.e., the most popular coverage, the lowest premium, the highest premium, etc.) to determine a likely tier or level for the user. The system server 110 may further use existing information about the user if available such as a current insurance coverage and premium paid by the user to determine the tier level.

If there is no records having the same zip code, or otherwise no matching records in the database 115, the system server 110 may provide a message like “If any matched results are available we will notify you by email” to the user's computer 105. The system server 110 may further store the user's information for future use in the database 115. If another user connects and provides similar PUI as the previous user, or the database 115 is updated to include a record with matching PUI, the system server 110 may notify the user that the comparison is available through an email or other communication method.

If the system server 110 is able to determine a likely level or tier of the user, the system server 110 may select an appropriate message to provide to the user based on the design of an administrator associated with the server 110. In some implementations, the message may include what is referred to herein as comparison data. The comparison data include all or a summary of the matching records and/or results and the advice message may then be transmitted to the user's computer 105.

In some implementations, the comparison data may include appropriate insurance advice for the user based on the determined level or tier of the user. In some implementations, the insurance advice may include known premiums associated with the determined level or tier of the user for a variety of insurance providers and a variety of coverage levels. The advice may then be displayed on a display screen of the computing device 105 associated with the user. In some implementations, the advice may further include the information determined by the system 110 using the PUI provided by the user (e.g., the lowest insurance premium, the highest insurance premium, the insurance company providing the lowest insurance premium, and the insurance company providing the highest insurance premium). The advice may further include hyperlink website addresses or URLs for the insurance companies associated with each premium and/or a link through which the user may contact an agent 130 to purchase the indicated insurance. In some implementations, the agents 130 may purchase redirects that allow their link to be included with a provided result.

The server system 110 may further store the PUI provided by the user if the data passes an optional validity test in the database 115. The PUI may be stored as a record in the database 115 and may be used for future comparison requests by other users, for example. The stored data may also be used for insurance marketing purposes by an advertiser 140. For example, the data may be collected into reports and may be sold to an advertiser 140 for marketing purposes, or to calculate average insurance premiums by region, for example.

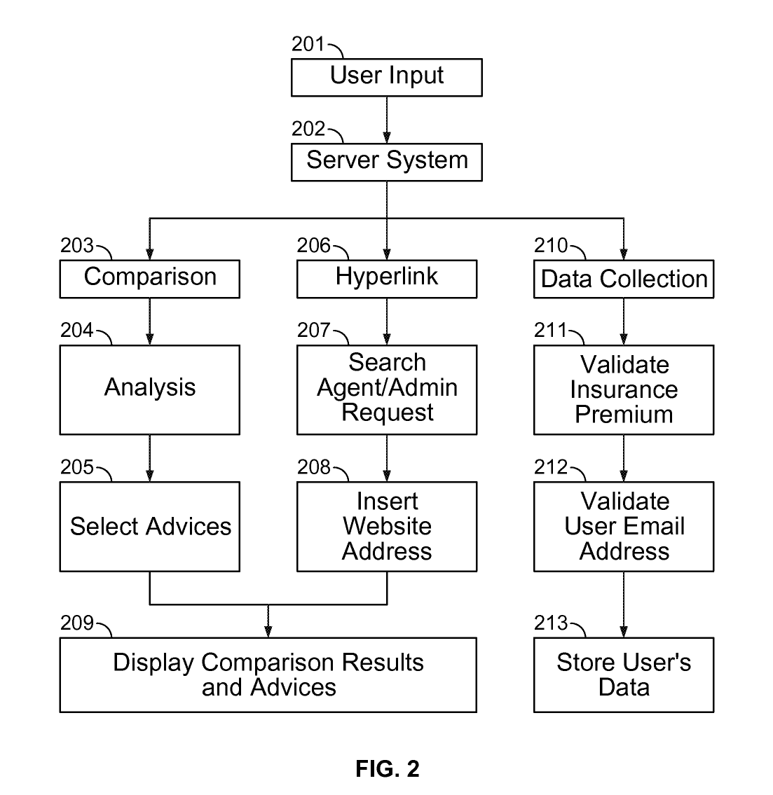

FIG. 2 is a flowchart showing an example of an insurance quote generation and retrieval method. In FIG. 2 the tasks to be initiated based on a user's PUI and to be performed by the system server 110 are shown in separate columns. In particular, redirection related tasks are shown in the left column, insurance comparison and advice related tasks are shown in the middle column and input data collection related tasks are shown in the right column.

A user provides PUI information to a website associated with the server 110 at 201. The server system 110 receives the PUI information at 202. Based on the PUI input information, the server system 110 may search for matching records in the database 115. The server system 110 may then use the matching records to determine the most popular insurance coverage, the lowest insurance premium, the highest insurance premium, the insurance company providing the lowest insurance premium, and the insurance company providing the highest insurance premium from the matched records.

The server system 120 determines a level for the user U1 based on the matched records and the PUI information provided by the user at 204.

The server system 120 determines appropriate advice for the user based on the determined level at 205. The advice may be based on the determined level, settings created by an administrator, and input from one or more insurance agents 130. For example, the advice may instruct the user that they are paying too much for their insurance when compared to other's with the same zip code.

The server system 120 may begin to insert one or more hyperlinks into the selected advice at 206. The hyper links may include redirections to websites associated with one or more agents 130 who purchased redirection credits. In order to determine which redirections to include in the hyper links, the server system 110 may consider the zip code or other PUI associated with the advice and determine one or more agents 130 who purchased redirection credits with respect to the zip code or other PUI. The server system 110 may insert the website addresses associated with the determined one or more agents 130 and redirection credits into the advice at 208.

The advice and results including redirections, are transmitted to the computer 105 associated with the user at 209. If the user selects a URL corresponding to any of the redirections, the redirection credits associated with that agent 130 may debited and logged.

After providing the results to the user, the server system 110 may begin a data collection phase at 210. As a first part of the data collection phase, the server system 110 may validate the premium provided by the user if any at 211. The PUI provided by the user may include an insurance premium paid currently by the user. In some instances, to protect the integrity of the data, premium data that is either too low or too high, may be discarded by the system. The validity of the insurance premium may be determined by comparing the insurance premium with a valid range that is provided by a user or administrator. An insurance premium is valid if it is within the range.

An email address associated with the user is validated by the system 110 at 212. The email address may be validated using a variety of well known email validating techniques.

If the email address and the premium provided by the user are both valid, then the system 110 may store the PUI provided by the user at 213. The PUI may be stored as a record in the database 115 and may be used to provide insurance advice to other users of the system 110.

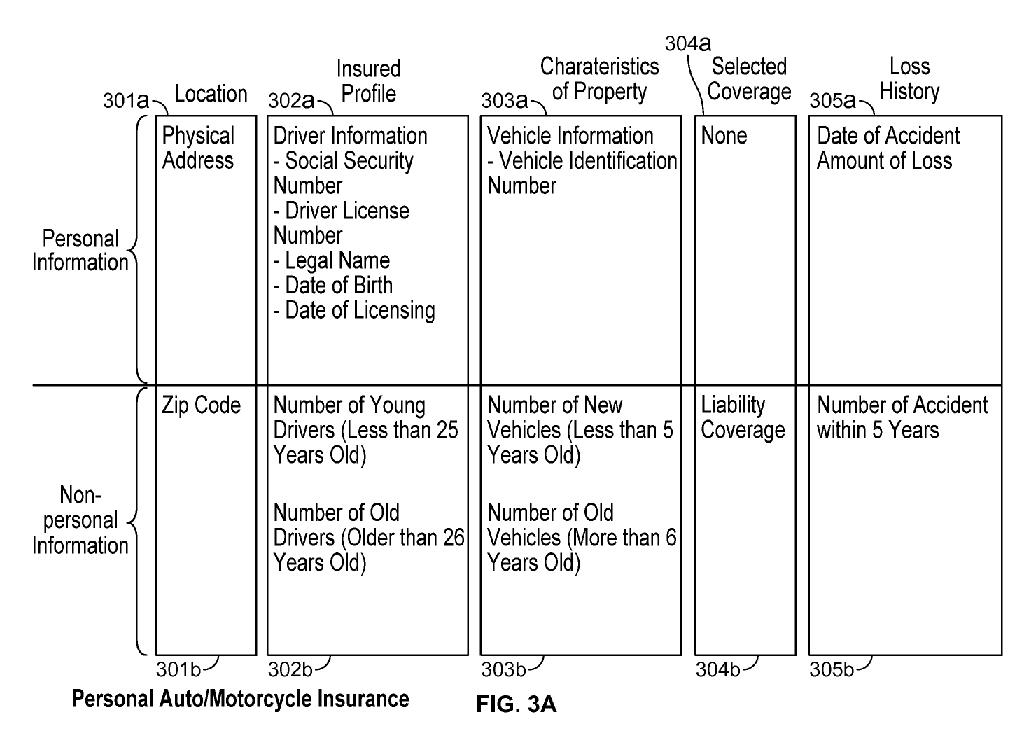

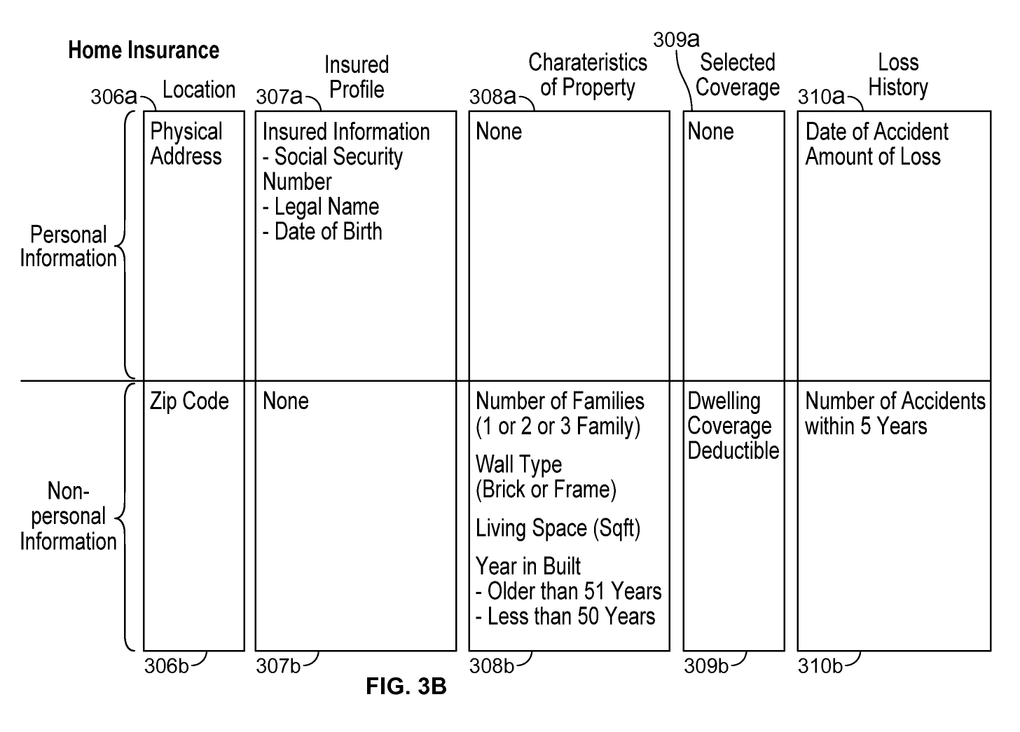

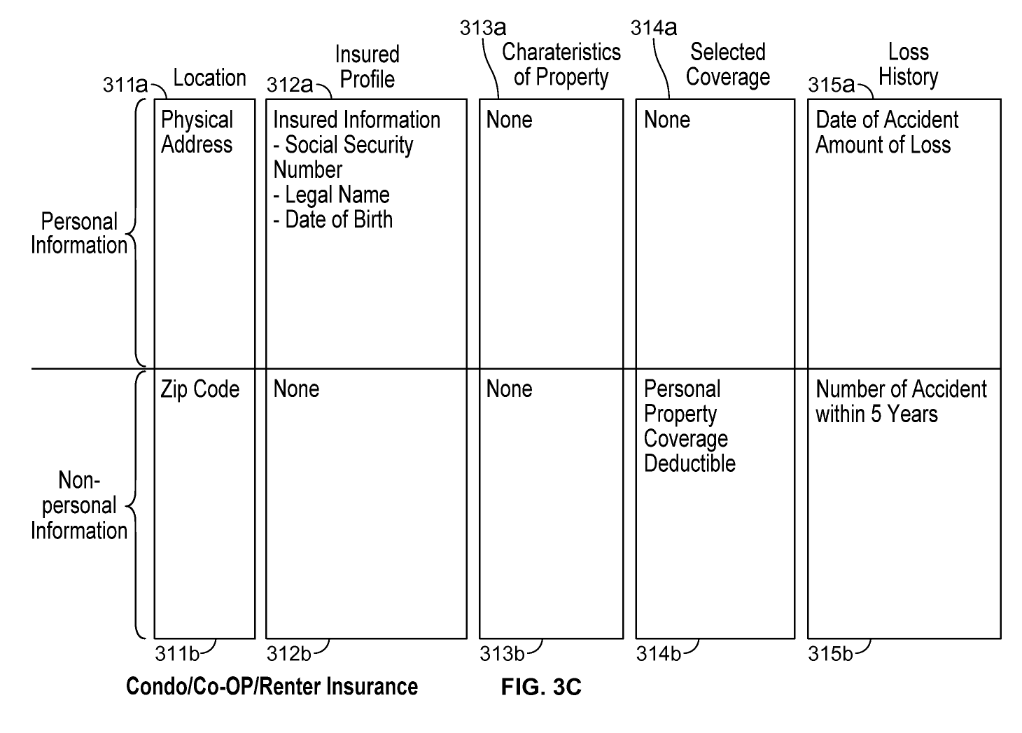

FIG. 3A-3C are illustrations of PUI and PII for various types of insurance types. In particular, FIG. 3A illustrates the PII and PUI components of personal auto or motorcycle insurance. The PII and the PUI is divided into example categories such as location, insured profile, and characteristics of property, selected coverage, and loss history. Other categories may also be used.

As illustrated, the location category is divided into physical address 301a as PII, and zip code 301b as PUI. The insured profile category is divided into social security number, driver license number, legal name, date of birth, and date of licensing 302a as PII, and number of young driver(s) (below twenty five years old) and number of old driver(s) (above twenty six years old) 302b as PUI. The characteristics of property category is divided into Vehicle Identification Number (VIN) 303a as PII, and number of new vehicles(less than five years old) and number of old vehicles (more than six years old) 303b as PUI. The selected coverage category is divided into none 304a as PII, and liability coverage 304b as PUI. The loss history category is divided into date of accident and amount of loss 305a as PII, and number of accident within five years 305b as PUI.

FIG. 3B illustrates the PII and PUI components of home insurance. The PUI and PII may be divided into categories such as location, insured profile, characteristics of property, selected coverage, and loss history. The location category may be divided into physical address 306a as PII, and zip code 306b as PUI. The insured profile category is divided into social security number, legal name and date of birth 307a as PII, and none 307 as PUI. The characteristics of property category is divided into none 308a as PII (i.e., there is no characteristic of a property that could be considered personal), and number of families (1 or 2 or 3 Family), wall type (brick or frame), living space (sqft), and year in built (older than fifty one years or less than fifty years) 308b as PUI. The selected coverage category is divided into none 309a as PII, and dwelling coverage and deductible 309b as PUI. The loss history category is divided into date of accident and amount of loss 310a as PII, and number of accidents within five years 310b as PUI.

FIG. 3C illustrates the PII and PUI components of condo, co-op or renter's insurance. As shown the PII and PUI is divided into categories such as location, insured profile, characteristics of property, selected coverage and loss history. The location category is divided into physical address 311a as PII, and zip code 311b as PUI. The insured profile category is divided into social security number, legal name and date of birth 312a as PII, and nothing 312b as PUI. The characteristics of property category is divided into none 313a as PII, and none 313b as PUI. The selected coverage category is divided into none 314a as PII, and personal property coverage and deductible 314b as PUI. The loss history category is divided into date of accident and amount of loss 310a as PII, and number of accidents within five years 310b as PUI. The PII and PUI in FIG. 3A-3C are illustrated to explain the meaning of PUI and PII with respect to the different types of insurance, however other types PUI and PII may be supported.

The examples of PUI in FIG. 3A-3C are what most insurance companies use to determine the tier or level of a user or customer. Accordingly, the system 110 may request some or all of the indicated PUI from a user to estimate what tier or level that user belongs to for purposes of estimating one or more insurance premiums for a user with respect to one or more insurance companies.

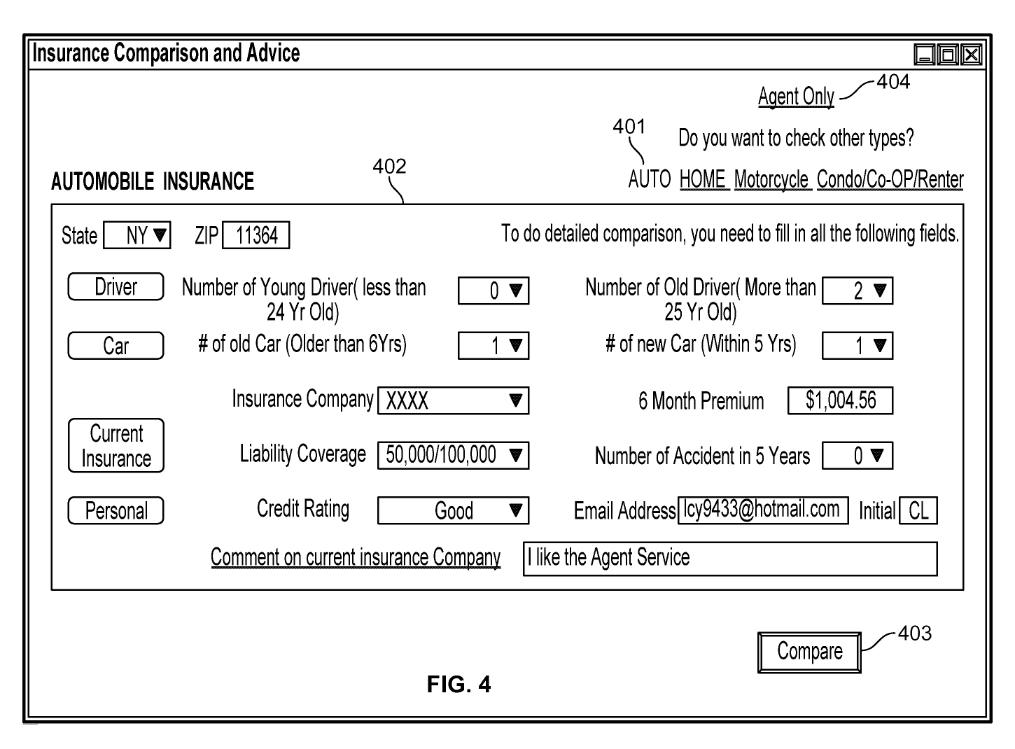

FIG. 4 is an example input screen via which a user may provide PUI to a server 110 to receive one or more auto insurance premiums for comparison. The input screen may be displayed to a user at their associated computer 105 by the server 110.

In the example shown, auto insurance PUI specific input fields 402 are populated in accordance with a selection of auto insurance by the user as indicated by the “auto” 401 user interface element. If the user selects a different user interface element, the input fields 402 may be populated with fields that are more appropriate to the type of insurance selected. For example if the user selects “Motorcycle”, the input fields 402 may be updated to request PUI associated with motorcycle insurance.

As illustrated, the input fields 402 for auto insurance include, state, zip or postal code, number of young driver(s) (below twenty four years old), number of old driver(s) (above twenty five years old), number of old car(s) (more than six years old), number of new car(s) (less than five years old), liability coverage, number of accidents in five years, credit rating, and email address. In addition there is a field through which the user may provide any comments on their insurance company or agent, as well as provide their initials. Generally speaking, all of the information requested in the input fields 402 is PUI.

In some implementations, a user or administrator associated with the server 110 may determine the fields in the input fields 402 and may restrict what type or format of data that may be entered into each of the fields. The administrator may further specify an error or warning message that is displayed for a user if they enter the wrong type of information. The administrator may further specify the location of a scrollbar, text displayed to the user, as well as any functions that may operate on selected input fields. These functions may enforce that the user enters a valid state into a state field, or limit the user to predetermined choices or numerical ranges.

After the user enters all of the requested information, the user may select the compare button 403, and the input data may be transmitted to the system 110 for the comparison step. The system 110 may convert the input data received from the user into a format suitable for storage or use by the database 115. Where the user is an advertiser 140 or an agent 130, the agent or advertiser may access agent or advertiser specific information by selecting the “agent only” link 404.

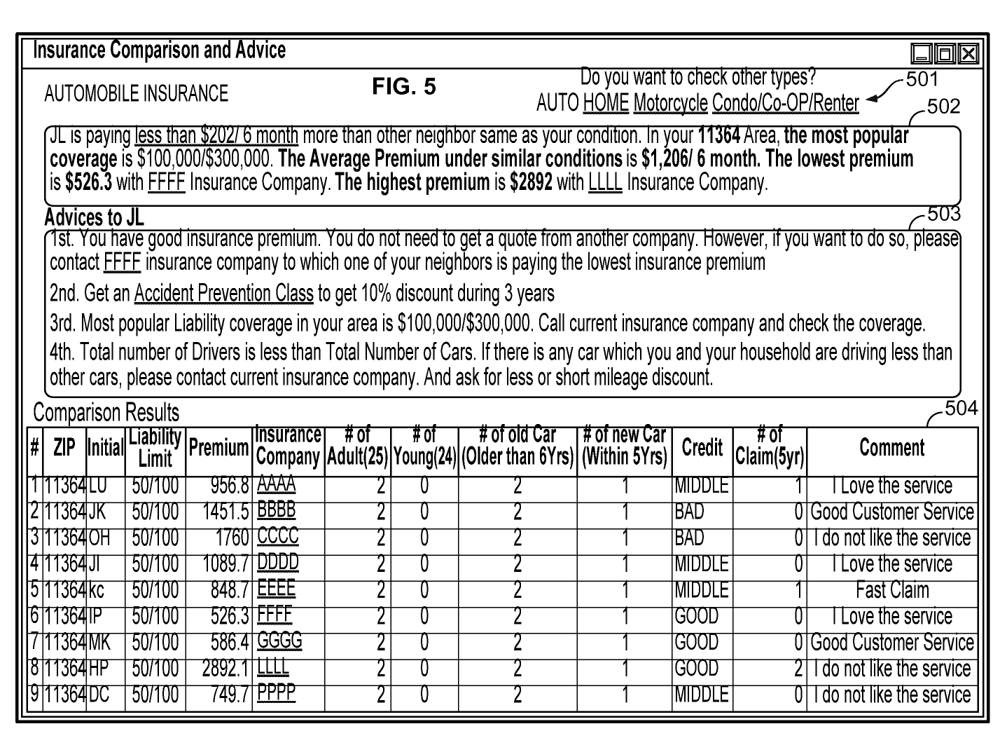

FIG. 5 is an example display screen that may be generated by the system 110 using the information provided by the user interface described in FIG. 4. The screen shows the comparison information and advice that is generated for the user based on the PUI provided by the user with respect to FIG. 4. As illustrated, the screen shows a comparison summary frame screen 502, an insurance advice frame screen 503, and a matched results frame screen 504.

The comparison summary frame screen 502 includes the most popular liability coverage, the average insurance premium, the lowest insurance premium, the highest insurance premium, the insurance company providing the lowest insurance premium and the insurance company providing the highest insurance premium among the matched results based on the information provided by the user and the records in the database 115. In some implementations, the system 110 compares the input data with data from records of the database 115 that match some or all of the input data. To calculate the most popular coverage result, the system 110 may count the number of records having the same insurance coverage within a zip code or area identified by the user. To calculate the average insurance premium, the lowest insurance premium, the highest insurance premium, the insurance company providing the lowest insurance premium and the insurance company providing the highest insurance premium, the system 110 may similarly use data from the matching or partially matching records of the database 115.

Based on the calculated results and the information provided by the user, the system 110 may determine the level or tier of the user among the matched results. In some implementations, to determine the level or tier of the user, the system 110 may determine if the user's current insurance coverage is higher or lower than the most popular coverage in the same area and if the user's current insurance premium is higher or lower than the average premium in the matched results. If the system 110 is able to determine the level or tier of the user, the system 110 may select appropriate advice messages and displays the messages at the insurance advice frame screen 503. The particular messages may be preselected by a user or administrator associated with the system 110. The messages may be stored and/or indexed in a log, for example. If the user is paying too much, the messages may include “You are paying insurance premium higher than the other neighbors who have similar conditions. AAAA insurance company is providing the lowest premium in your area. Please try to get a quotation through AAAA insurance company”. If the user is paying less than an average amount, the message may include “Your insurance premium is lower than the average insurance premium in your area. Please try to take Accident Prevention Class (APC) and get around 10% additional discounts on your auto insurance through three years”. If the total number of car(s) is more than the total number of drivers, the message may include “Your policy has more cars than drivers. Contact insurance company or agents to check if you are eligible for short mileage discount or low usage discount on the car(s)”. If the user has lower insurance coverage than the most popular coverage in the same area, the message may include “The appropriate amount of coverage is very important when you have accident. Please contact your insurance company and ask about an increase of your current coverage”. If there are old driver(s) as well as young driver(s), the message may include “You have young driver(s) who may be student(s). If yes, please contact your insurance company or agent and ask for any discounts related to students”. If there are old car(s), the message may include “You may have full coverage on the old car(s). If yes, please contact your insurance company or agent and discuss about the removal of full coverage on the cars to save the current insurance premium”. Other messages may also be displayed.

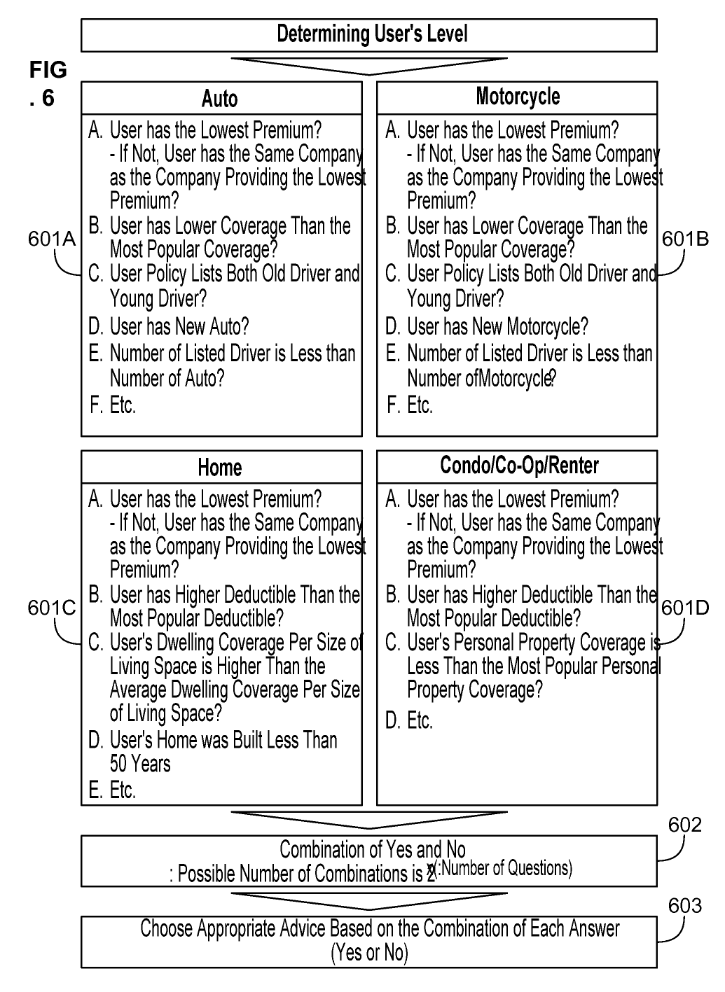

FIG. 6 is an illustration of a method for determining a tier or level for a user. As illustrated there are four types of insurances listed and a set of questions corresponding to each type of insurance. The method may begin by asking the user questions corresponding to the appropriate insurance type. The box 601A includes the questions that may be asked by the system server 110 for automobile insurance. The box 601B includes the questions that may be asked by the system server 110 for motorcycle insurance. The box 610C includes the questions that may be asked by the system server 110 for home insurance. The box 610D includes the questions that may be asked by the system server 110 for condo, co-op, or renters insurance. In order to determine an insurance tier for a user, the system server 110 may determine the answers to the questions corresponding to the type of insurance that the user is requesting.

At 602, the system server 110 may determine a combination of yes or no answers to the questions provided in the appropriate box 610. As may be appreciated there may be as many as 2^{x} possible combinations of unique yes and no answers, where x is the number of questions in each box.

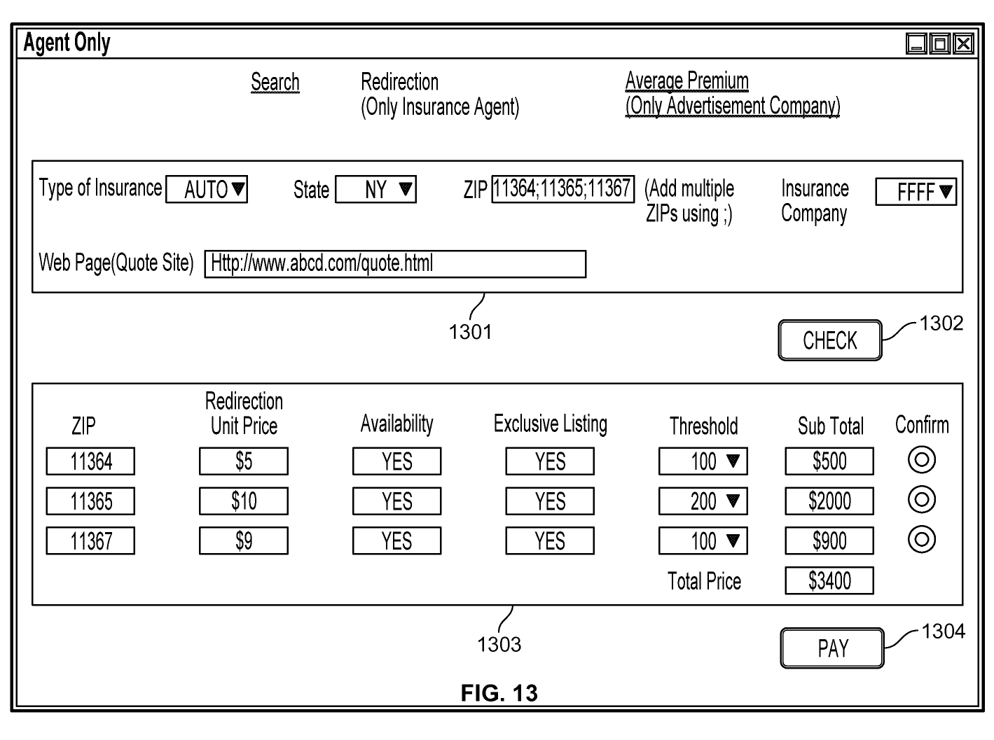

At 603, the system server 110 may select an appropriate advice based on the combination of yes or no answers. For example, the advice may be selected using a mapping of yes and no answers to advice. In addition, advice may be provided to the user in the insurance advice frame screen 503. In addition, any matching records and/or results from the database 115 may be displayed to the user in the matched results frame screen 504. In some implementations, the order of the results may be arranged from the lowest insurance premium to the highest insurance premium. In addition, the system server 110 may include hyperlink specific website addresses or URL information into each name of insurance company in HTML or XML that is displayed. The URLS may be selected an administrator associated with the system server 110 or by an insurance agent 130, for example. The URLS may redirect a user to a webpage associated with an agent 130 that sells the particular insurance product. In some implementations, the insurance agents 130 may purchase or bid on a number of times that the URL associated with the agent is placed along with a result, or may pay each time that a user selects or clicks on a provided URL. Such a system is described further with respect to FIG. 13, for example. In some implementations, the agent 130 may purchase redirection credits with respect to a particular zip code, for example.

If the system server 110 is unable to find any matching records in the database 115, the system server 110 may display a message to the user such as “We could not find any matched results in your area. We will notify you by email once matched results are available”. The system server 110 may then store an email address for the user in a mailing list, for example. If one or more records with PUI that is similar to the user are added to the database 115, the system server 110 may send an email message to the user alerting them of the matching record, and inviting them to connect to the system server 110.

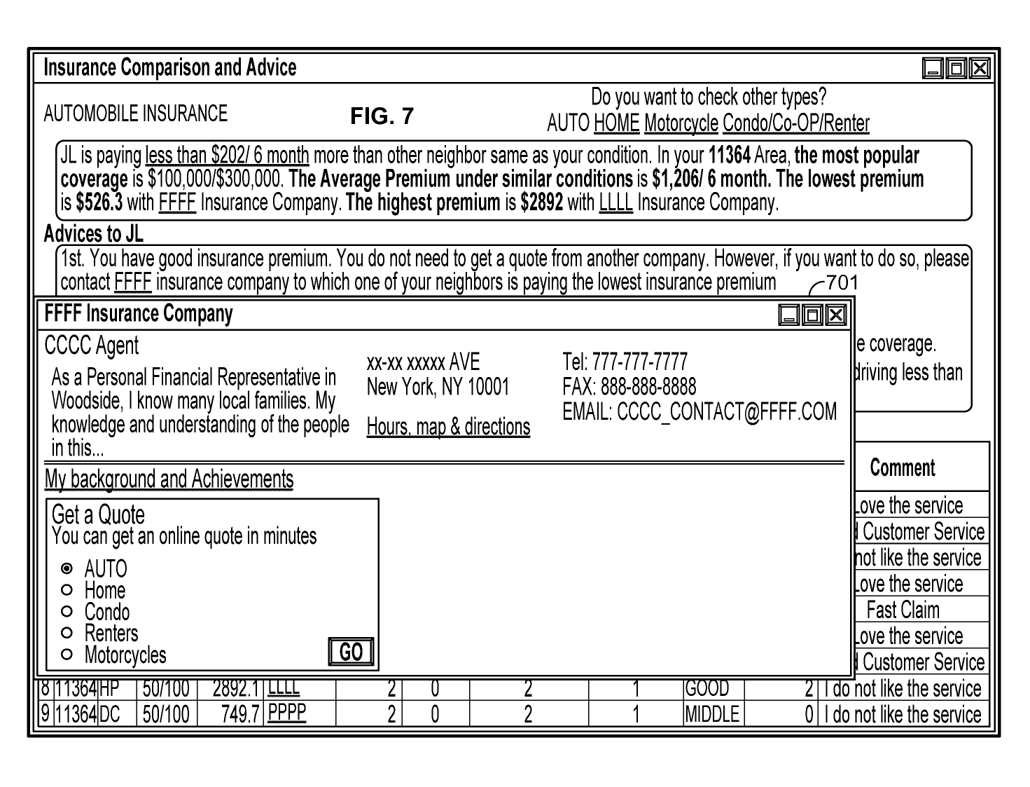

FIG. 7 illustrates a website displayed as a result of a redirection caused by a user selecting one or more displayed results or advices from the matched results frame screen 504 and/or the insurance advice frame screen 503. The redirection may have been purchased by an agent 130 associated with the redirection in the form of a redirection credit. As shown, the user has selected the hyperlink corresponding to the FFFF insurance company and the window 701 is displayed to the user. The window 701 may display information associated with an agent 130 of the insurance company like address, telephone number, fax number, email address, business hours, location, specialty, speaking language(s) etc. and, if available, a link for an online quotation. The redirection may have been purchased by an agent 130 associated with the redirection.

In some implementations, if the user selects to view more information from the window 701 (i.e., by selecting the “GO” button”), the system server 110 may redirect the user to a website associated with the insurance company or agent 130, store information associated with the redirection such as the time, website, IP address of the user, etc. The system server 110 may log the redirection to the database 115 and may charge or debit the insurance company or agent 130 an amount for the redirection.

In some implementations, the insurance agent 130 or insurance company may have purchased some number of redirection credits. The redirections may be specific to certain zip codes, for example. If the insurance agent 130 is out of redirection credits after the current redirection is processed, a message may be sent to the agent 130 to purchase more redirection credits. The insurance agent 130 may connect to the server system 110 to purchase more redirection credits and/or to view or audit the results of their previous redirections.

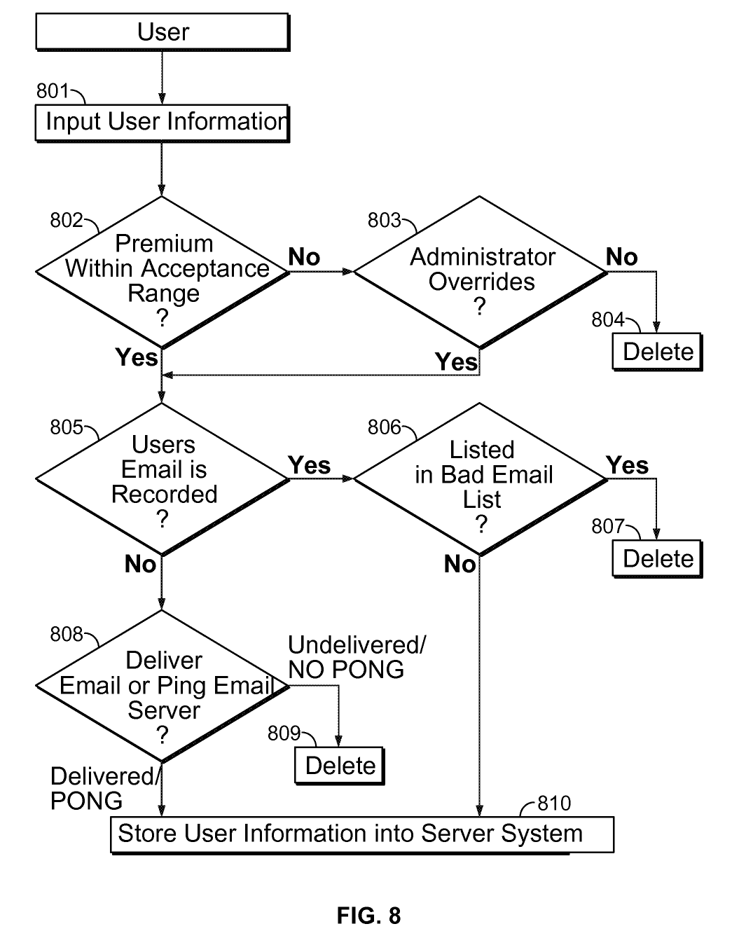

FIG. 8 is a flow diagram of a method for collecting of insurance data from general user's input. This routine validates the amount of insurance premium and user's email address to determine if the user is a reliable source, for example.

At 801 a user may input PUI to the system server 110. The user may input the information using an input screen such as the one shown in FIG. 4. The system server 110 may receive the data and may calculate the popular coverage, average premium, lowest premium, etc. based on the PUI. The system server 110 may select advice to provide to the user based on the calculations.

At 802, the system server 110 may determine if a determined insurance premium is within an acceptable range. The range may be set by an administrator, for example.

At 803, if the premium is higher than or lower than the allowable range, the system server 110 may request an administrator override. If the administrator determines not to allow the premium, the data will be deleted 804. If the administrator allows the premium, the method may continue at 805.

At 805, a determination is made as to whether the user's email address is recorded by the system server 110. If it is, a determination is made as to whether the email is listed in a bad email list at 806. If it is, the data may be deleted 807. If the email address is not in the bad email list, the system server 110 may store the PUI provided by the user in the database 115.

At 808, an email message may be sent to the user at the email address or an Internet Control Message Protocol (ICMP) packet, such as a PING, may be sent to an email hosting server associated with the email address. If the email address is verified (e.g., a response is received to the ICMP packet, or the user responds to the sent email, the PUI is stored in the database 115. Else, the PUI is deleted at 810.

In the case that the PUI is stored in the database 115, the stored data will be utilized to compare the insurance record with other users during specific periods of time, usually one year. After one year, the PUI may be deleted. The periods of time that a record is valid may be specified by a user or administrator.

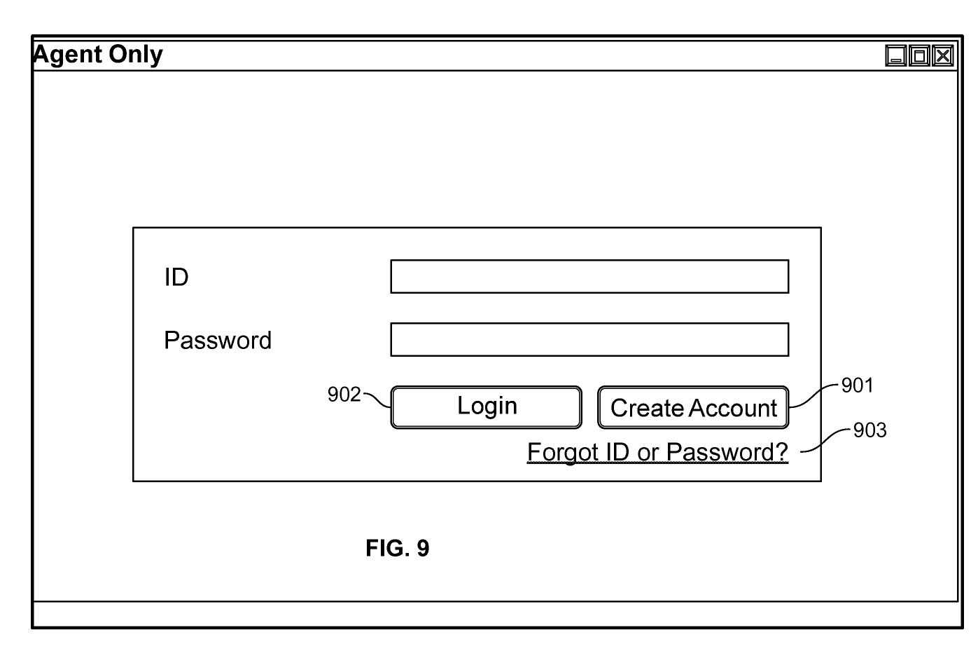

FIG. 9 is an example display screen showing a login web page that may be used by an insurance agent 130 or an advertiser 140. The insurance agent 130 or advertiser 140 may connect to the system server 110 and may see a web page such as the web page illustrated in FIG. 4. The agent 130 or advertiser 140 may select the link marked “Agent only” 404 and may receive the web page shown in FIG. 9. If the insurance agent 130 or advertiser 140 intends to create their own account, they may click on “create account” 901. If they already created the account, they may type in their ID and password in the screen and click on “login” 902. If they forgot or lost the information about their ID or password, they click on “forgot ID or password?” 903. The login system may be built via the well known internet based programming tools, such as PHP, MySql, ASP.NET, or Mssql, for example.

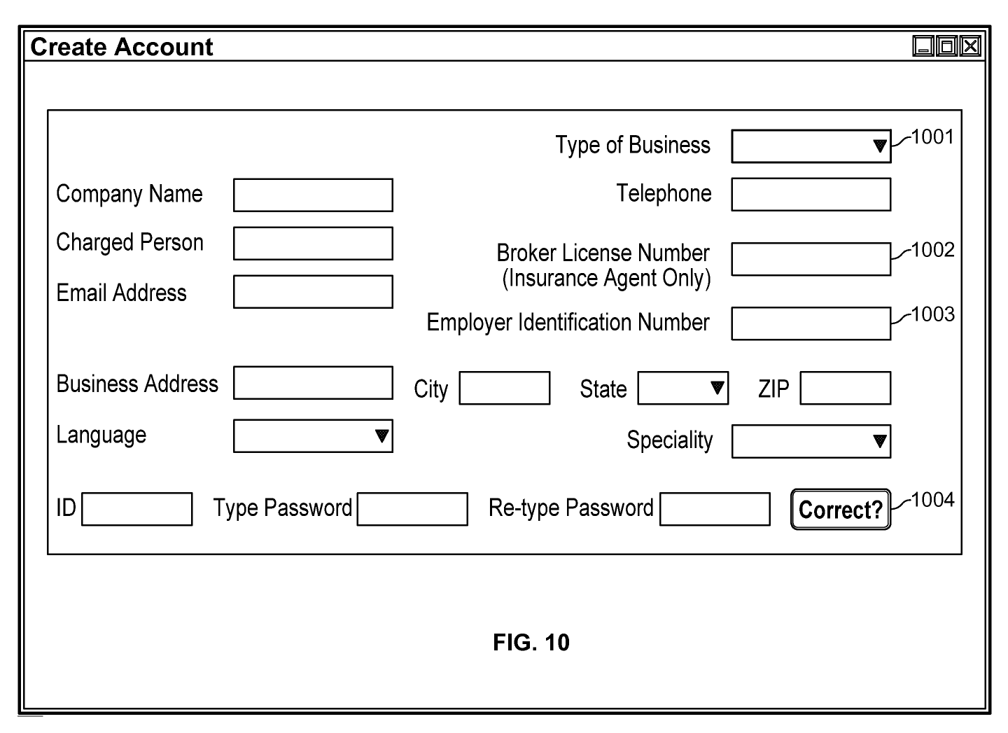

FIG. 10 is an example of a display screen for creating of an access account for an insurance agent 130 or an advertiser 140. The display screen may be a web page and may be provided after an agent 130 or advertiser 140 selects the create account 901 button. The screen includes various input fields including type of business 1001, company's name, telephone, charged person, broker license number 1002, email address, employer identification number 1003, email address, business address, service language, specialty, ID and password. Other fields may be supported.

After the insurance agent 130 or advertiser 140 has completed the form, the agent/advertiser may select the “correct?” button 1004, and the data in the form may be sent to the system server 110. The server 110 may check if a duplicate record exists in a user database, and if not, the system 110 may create an account for the agent 130 or advertiser 140. The agent 130 or advertiser 140 may then access their account using the registered ID and password provided in FIG. 9.

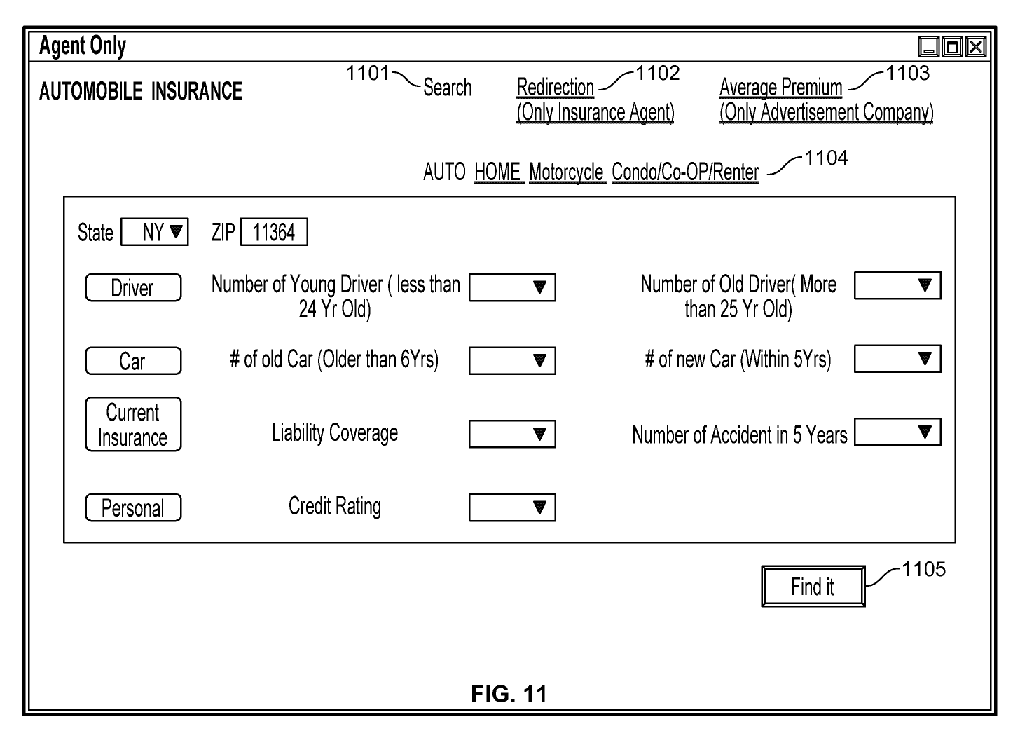

FIG. 11 is an example display screen showing an insurance information search page for use by an insurance agent 130 or an advertisement agency 140. The advertiser 140 or agent 130 may use the display screen to search or access insurance information. The agent 130 may purchase additional redirection credits by selecting “Redirection (only insurance agent)” 1102. The advertiser 140 can access to the average premium report by region or by insurance company or by type of insurance by clicking on “The Average Premium (only advertisement agency)” 1103. The type of insurance is set by default as “auto” 1104.

In some implementations, the advertiser 140 or agent 130 may use the input webpage to search by zip or postal code, number of young driver(s), number of old driver(s), number of old car(s), number of new car(s), liability coverage, and number of accidents within five years and credit rating, for example. The advertiser 140 or agent 130 may submit their search by selecting the “find it” button 1105. The agent 130 or advertiser 140 can change the type of insurance compared by selecting the other types of insurance listed on the links 1104.

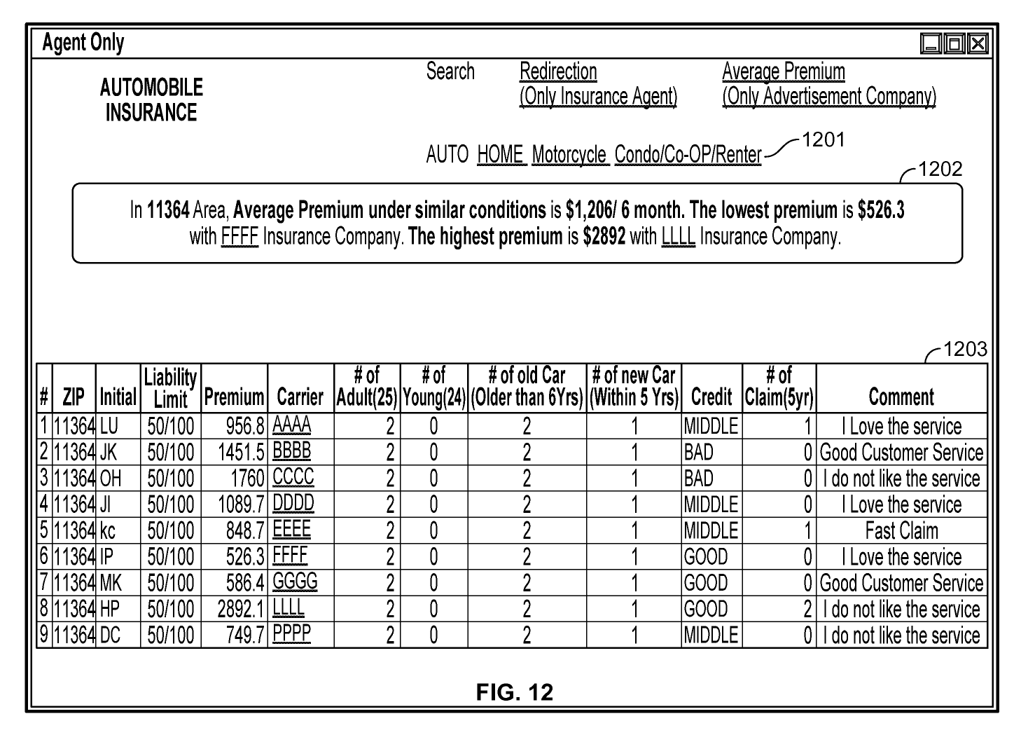

The system 110 may receive the search data from the agent 130 or advertiser 140 and may use the received data to search for the matching results and may provide the results to the advertise 140 or agent 130 in a results page. As example results page is illustrated with respect to FIG. 12. Not unlike the general user's search result page shown in FIG. 5, this page contains the average premium, the lowest premium, the highest premium, the insurance company providing the lowest premium, the insurance company providing the highest premium and any matched results. This webpage enables the insurance agent 130 or the advertiser 140 to learn how any redirection is working and to find which area is appropriate for further advertisement.

The type of insurance may be initially set as auto. The insurance agent 130 or the advertiser 140 may choose different types of insurance through the links 1201. If another type of insurance is selected, the system 110 may provide a webpage containing search input fields corresponding to the selected type of insurance. As shown in 1202, the web page may include the average premium, the lowest premium, the highest premium, the insurance company providing the lowest premium and the insurance company providing the highest premium. As shown in 1203, the matching records and/or results are displayed in detail. The order of results may be arranged by default from the lowest premium to the highest premium. If there are no matched results, the system 110 may display a message such as, “There are no matched results. Please try again later”.

FIG. 13 is an example display screen showing a redirection purchase page for an agent 130. The agent can check the availability for website redirection credits and purchase the redirection credits via this page. The insurance agent 130 may fill in the type of insurance, zip or postal code, state, insurance company and website address into the fields 1301. The webpage of FIG. 13 may allow for the insurance agent 130 to enter multiple zip codes through which the insurance agent 130 intends to advertise their website. After completion of the fields 1301, the insurance agent 130 may click on the “Check” button 1302 to check the availability of the requested redirections with the server 110.

The system 110 may receive the input data and may check if the selected insurance company in the provided zip or postal code(s) is occupied exclusively by a single agent 130. If not, the server 110 may calculate the average premium of the provided zip code(s). Based on the calculation, the system 110 may determine a price for an exclusive listing, and a redirection credit price according to the specific zip codes provided. The system 110 may display the determined results to the agent 130 in the window 1303.

The agent 130 may then choose one or more exclusive listings and the number of redirection credits desired for the available zip codes. If only the non-exclusive redirection service is available, the system 110 may not allow the insurance agent 130 to select an exclusive listing.

After the agent 130 selects their desired listings and thresholds, the agent 130 may click or select “confirm” next to each redirection. To finalize the purchase of the redirection credits, the agent 130 may select the “pay” button 1304. After payment is received by the server 110, the redirection credits are added to the database 115 such that a user may receive a redirection to a website associated with the agent 130 if they provide the corresponding zip codes.

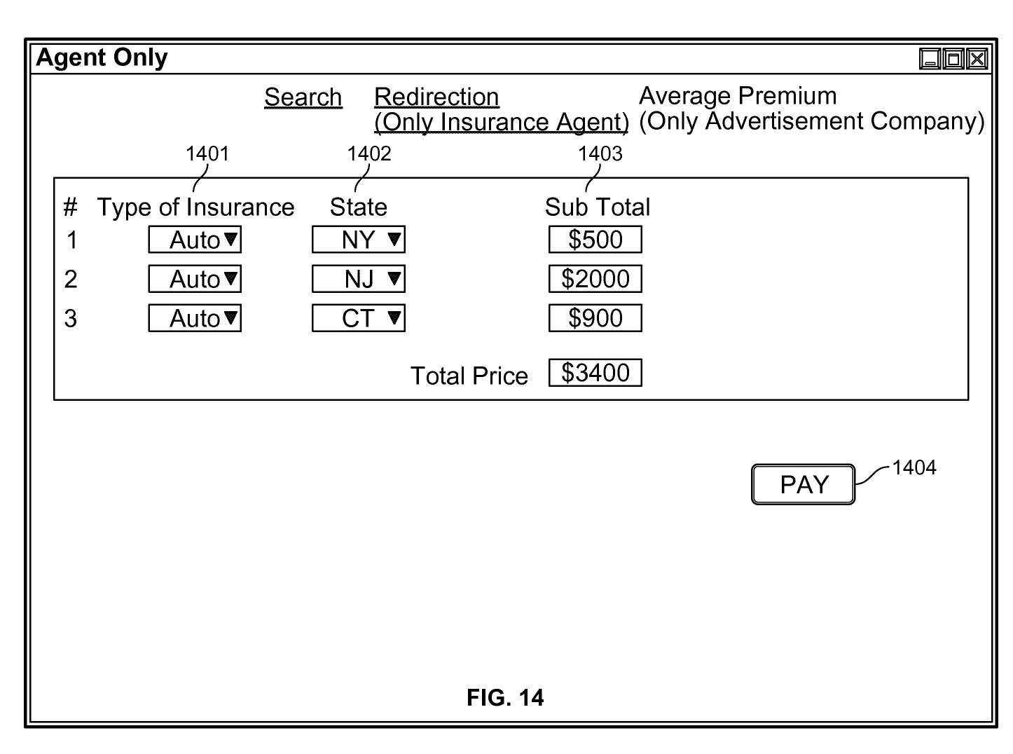

FIG. 14 is an example of a display screen showing the average premium report ordering page for an advertiser 140. The advertiser 140 can select a type of insurance 1401 by state 1402 and purchase an average premium report. The advertiser 140 may select the type of insurance among auto, home, motorcycle and condo, for example.

After an advertiser 140 selects a particular state, the server 110 receives the selection and displays the average premium for the selected state in the fields 1403. For example, if the advertiser selects ‘AUTO’ and ‘NEWYORK’, the system 110 calculates the average auto insurance premium for New York. If the advertiser 140 desires the corresponding report, the advertiser 140 may select the “PAY” button 1404. The server 110 may then transmit a payment webpage to a computer associated with the advertiser 140 and may enable the advertiser 140 to pay the amount for the order. If the advertiser 140 pays the amount, the system 110 extracts the average premium by state, by zip or postal code and by insurance company.

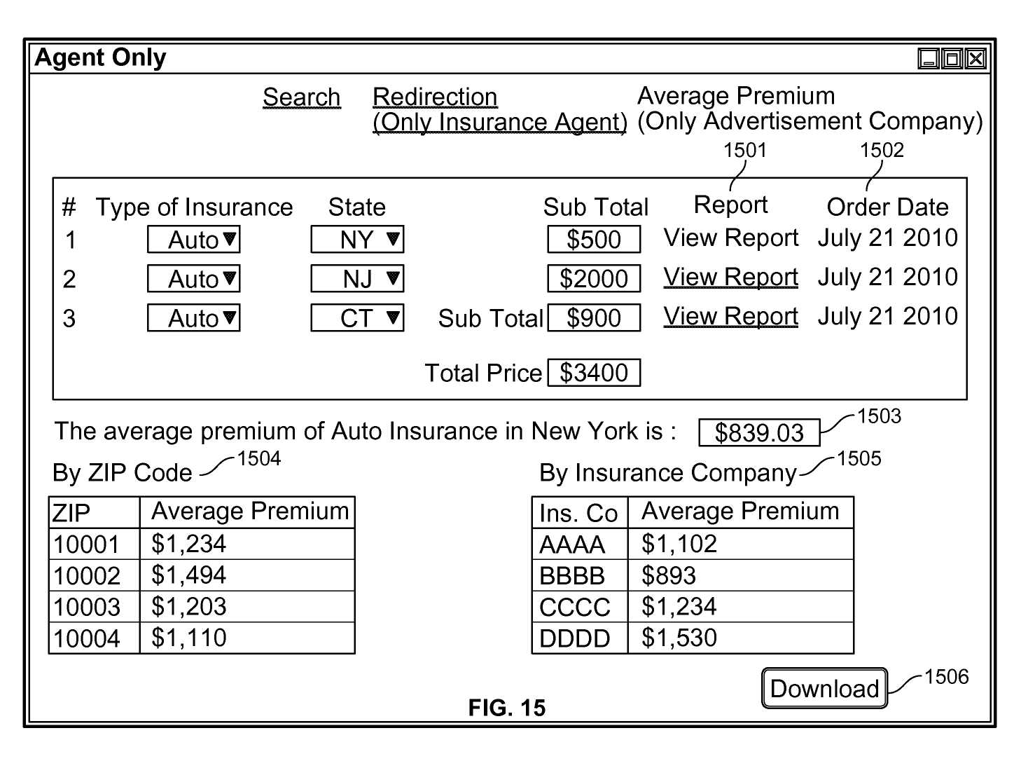

FIG. 15 is an example display screen showing the average premium report purchased by an advertiser 140. The advertiser 140 can access to the detailed reports which the advertiser 140 has ordered. The advertiser 140 may select a specific report among the list of the reports which can be identified by the selected type of insurance, state and the order date 1502, by selecting the “View Report” button 1501. Upon selection, the system 110 may retrieve the stored data from the database 115. The system 110 may transmit the selected report containing the average premium by state, the zip or postal code of the state, the average premium by zip or postal code 1504, and the average premium by insurance company 1505 to the computer associated with the advertiser 140. The various reports may be downloaded into the advertiser's computer in various file formats such as .csv or .xml by selecting the download button 1506.

With reference to FIG. 16, an exemplary system for implementing aspects described herein includes a computing device, such as computing device 1600. In its most basic configuration, computing device 1600 typically includes at least one processing unit 1602 and memory 1604. Depending on the exact configuration and type of computing device, memory 1604 may be volatile (such as random access memory (RAM)), non-volatile (such as read-only memory (ROM), flash memory, etc.), or some combination of the two. This most basic configuration is illustrated in FIG. 16 by dashed line 1606.

Computing device 1600 may have additional features/functionality. For example, computing device 1600 may include additional storage (removable and/or non-removable) including, but not limited to, magnetic or optical disks or tape. Such additional storage is illustrated in FIG. 16 by removable storage 1608 and non-removable storage 1610.

Computing device 1600 typically includes a variety of computer readable media. Computer readable media can be any available media that can be accessed by device 1800 and include both volatile and non-volatile media, and removable and non-removable media.

Computer storage media include volatile and non-volatile, and removable and non-removable media implemented in any method or technology for storage of information such as computer readable instructions, data structures, program modules or other data. Memory 1604, removable storage 1608, and non-removable storage 1610 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer storage media may be part of computing device 1800.

Computing device 1600 may contain communications connection(s) 1612 that allow the device to communicate with other devices. Computing device 1600 may also have input device(s) 1614 such as a keyboard, mouse, pen, voice input device, touch input device, etc. Output device(s) 1616 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the processes and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be affected across a plurality of devices. Such devices might include PCs, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
receiving personally unidentifiable information (“PUI”) from a user at a computer device;
determining one or more records from a database of records that match some or all of the received PUI by the computing device; and
providing insurance advice to the user based on the determined one or more records to the user by the computing device.

2. The method of claim 1, further comprising validating some or all of the PUI, and if validated, storing the PUI as a record in the database.

3. The method of claim 1, wherein the PUI comprises a current insurance premium and an email address, and validating some or all of the PUI comprises determining that the current insurance premium is within an acceptable premium range and that the email address is a valid email address.

4. The method of claim 1, wherein the PUI comprises a zip code and a current insurance premium paid by the user, and determining one or more records that match some or all of the received PUI comprises determining one or more records that have a same zip code as the PUI.

5. The method of claim 4, further comprising calculating a highest premium paid by users, a lowest premium paid by users, and an average premium paid by users using the determined one or more records that have a same zip code as the PUI, and providing the insurance advice based on the calculated highest premium paid by users, lowest premium paid by users, and average premium paid by users.

6. The method of claim 5, wherein the advice is whether the current insurance premium paid by the user is higher or lower than the average premium paid by users.

7. The method of claim 6, further comprising determining an insurance agent who purchased a redirection credit with respect to the zip code of the PUI, and including a redirection link in the advice to a website associated with the determined insurance agent where the user can purchase insurance.

8. The method of claim 7, further comprising receiving an indication that the user selected the redirection link, and debiting a redirection link balance associated with the agent upon receiving the indication.

9. The method of claim 8, further comprising determining that a redirection link balance for an agent has fallen below a threshold, and contacting the agent to purchase additional redirection links if it is determined that a redirection link balance for an agent has fallen below a threshold.

10. The method of claim 1, wherein the insurance is automotive insurance.

11. The method of claim 1, wherein the insurance is one of homeowners insurance, motorcycle insurance, condo insurance, co-op insurance, or renter's insurance.

12. A method comprising:
receiving a request to purchase a number of redirection credits from an insurance agent at a computing device, wherein the request includes a zip code, an identifier of an insurance company and a type of insurance;
receiving a website address corresponding to the redirection request by the computing device;
storing the website address with the number of redirection credits by the computing device;
receiving a request for insurance advice for the type of insurance and the zip code by the computing device;
generating insurance advice based on the received request by the insurance company, the advice including an insurance product from the identified insurance company; and
including the received website address in the generated advice by the computing device.

13. The method of claim 12, further comprising providing the generated advice to a user.

14. The method of claim 13, further comprising determining that the user selected the received website address, and debiting the number of redirection credits.

15. The method of claim 14, further comprising determining that the number of redirection credits is below a threshold, and contacting the insurance agent based on the determination.

16. The method of claim 15, wherein the type of insurance is automobile insurance.

17. The method of claim 15, wherein the type of insurance is one of homeowners insurance, motorcycle insurance, condo insurance, co-op insurance, or renter's insurance.

18. The method of claim 15, further comprising determining if the requested redirection credits are available.

19. The method of claim 18, further comprising only storing the redirection credits if the requested redirection credits are available.

20. The method of claim 12, wherein the advice is whether a current insurance premium paid by the user is higher or lower than the average premium paid by other users.
